(19) United States
(12) Patent Application Publication
(10) Pub. No.: US 2026/0287208 A1
(43) Pub. Date: Sep. 24, 2026

(54) ELECTRIC HEATING DEVICE WITH OPEN STRUCTURE AND POWER REGULATOR

(71) Applicant: EMMESTEEL S.R.L., Campodarsego (PD) (IT)

(72) Inventor: Ugo MARAN, Campodarsego (PD) (IT)

(21) Appl. No.: 19/473,206

(22) PCT Filed: Apr. 2, 2024
(86) PCT No.: PCT/IB2024/053167

§ 371 Date: Oct. 7, 2025

(30) Foreign Application Priority Data
Apr. 7, 2023 (IT) 102023000006888

(51) Int. Cl. F24H 15/156; A47K 10/06; F24H 3/00; F24H 15/254

(52) U.S. Cl. CPC F24H 15/156; A47K 10/06; F24H 3/002; F24H 15/254

(57) ABSTRACT

Electric heating device (100) with CPC constant power heating cable (10) inserted within an open structure (200) with core profiles (201) and/or covering elements (202), being rapidly assemblable with direct connection of said CPC (10) with the power grid and/or with a control unit (110), without using power cables. Said electric heating device (100) mountable with any orientation, said CPC (10) having a connection both at the head and at the base of said structure (200). The electric heating device (100) has a power regulator (111) with software (112) in said control unit (110) which carries out a control of the electric power so as to keep the flow of energy towards the CPC (10) constant as a function of the desired temperature, preventing switch-off and switch-on cycles at maximum power and allowing the simultaneous use of multiple appliances.

### FIELD OF THE ART

The invention refers to the field of heating devices. Still more specifically, the invention is adapted to provide an electric heating device which uses the action of heating a cable with constant power inserted within its structure and adjusts the operating thereof with a suitable power regulator.

### PRIOR ART

In the past, the heat regulation systems such as radiators were installed for a single reason: to ensure a hot climate, in order to be better prepared for the coolest seasons. To justify this, quite a limited range of products were present on the market; indeed very few variants were present, with different length and width standards, but also with nearly identical form and design. They mainly satisfied use needs rather than enhancing the aesthetic appearance of one's home, among other things providing basically one color selection. In recent years, there has been a reassessment of such instruments, with the radiator that is now longer just a mere heating element, but rather takes on an actual role as a furnishing element within the world of interior design. Its style can be particular and unusual, with original shapes, or it can have linear and essential forms.

Most of the radiator models are modular, with different dimensions that allow being adapted to the space and plant requirements. In commerce, both horizontal and vertical arrangements can be found. The attainment of electric radiator on the market often consists of electrifying a conventional hydraulic heater through the insertion of a liquid at its interior (water or glycol) adapted to form a kind of “hermetic recipient” therewith, heatable by a reinforced cartridge heating element. The heating element, with stem shape, is inserted in the manifold of the towel warmer in the power approximately close to the emission capacity of the towel warmer in relation to its size and is always oversized in order to speed up the heating of the liquid. The heating element heats the liquid with which it is in contact while a thermostat or multiple thermostats inserted in the upper part of the stem of the cartridge adjust the intensity of heat developed that they develop (30°-60°-80° managed by a small step control placed at the base in the models of high-quality producers). There is however a problem, since the liquid heated within a hermetic recipient is expanded proportionally with the temperature, creating a pressure in the heater as a function of the temperature present in the room, which increases if a towel is placed on this. In such context, the intervention of a thermostat is of fundamental importance in the use of the radiator at maximum power, indeed this provides for carrying out continuous switch-off and switch-on cycles for the cartridge, leading to a considerable delay in the attainment of the desired temperature together with poor energy efficiency.

An example of a patent that attempts to resolve several of the above-described problems is the object of the patent application ITMI20061579A1 by G. DE LONGHI. The invention describes a radiator for heating an environment that comprises electric heating means adapted to generate a natural circulation of a heat-carrier fluid. The radiator has two manifolds and various emitters connected thereto, within which the heat-carrier fluid is situated which, when heated by a cartridge heating element inserted in the manifold, transmits the heat to the entire device.

Another possibility for dry electric radiators is that of passing a heating element within the tubes, a solution which has the great advantage of ensuring a more immediate and uniform heating of the entire radiator.

There are multiple patents that are involved with providing solutions of various type in this technological field.

One example is the object of the patent application GB2212037A by K. PEARCE. The invention refers to an electric towel warmer. The device comprises transverse and vertical tubular elements that are joined by hollow spherical connectors. Within the tubular elements, a flexible heating cable is passed through, contained within a sheath of electrical isolating material. The cable include active heating zone arranged within the tubular elements in which a section of the heating element is connected to current wires such that there is a current path from one current conductor to the other through the element. The sections of the cable arranged within the vertical tubes have passive zones in which there is no current path through the corresponding section of the heating element. The electricity is supplied to the heating cable by means of a hidden power cable that is extended through the end of a tubular section which is adapted to mounting against the surface of a wall or floor.

Another example is the object of the patent application EP3339764A1 by R. SPERANZON and S. VALENTE. The invention refers to a modular device for heating an environment, to the process for its attainment and to the relative mounting kit. The device has a modular structure which comprises at least an upright and a plurality of modules that can be assembled together and are such to be slidably inserted on the upright. Within the upright and modules, a flexible heating electric cable is then made to pass through.

The inventions reported up to now merely as a non-limiting example are representative of the presently-available inventions and technologies.

The inventions reported, while providing solutions of various type to the abovementioned problems, have a series of limits and intrinsic problems. None of the abovementioned inventions in fact allows a flexibility, during assembly, such to ensure the installer the possibility to mount the device, orienting it in any direction (rotating it on the plane parallel to the support on which it is mounted), nor allows the installation of a control unit in any position subsequent to said orientation. The abovementioned inventions have in fact suitable power cables positioned in specific zones, or even control units mounted directly on the uprights of the device. The latter abovementioned characteristic has shown to be particularly problematic in the heating devices in which the heat is diffused in a uniform manner, since also the control unit and all the electrical/electronic components at its interior are subjected to the continuous variations of heat of the device. Also in the presence of suitable insulation, the external surface, in contact with buttons and/or screens, will still have the temperature of the radiator, and in any case the insertion of thermal insulation renders the mounting more complex, slow, costly and constrained to specific positions. Additionally, the abovementioned inventions have the problem of controlling the temperature and hence the power delivered by the flexible electric cable and/or by the cartridge heating element through switch-off and switch-on cycles, which not only reduce the energy efficiency of the device, but also involve a significant occupation of the energy availability, for example in a home, negatively affecting the possibility to turn on multiple appliances simultaneously with the heat devices. All of the abovementioned inventions, notwithstanding the passage of a flexible heating cable, then have cold zones caused by the “coil” shape in which the cable is passed within the device.

Another important aspect is that most of the electric heating devices present on the market are made with a rigid structure, composed of tubes welded to manifolds. This type of “rigid” structure with the inlet of the heating element, into the radiant body, generates annoying noises (ticks) during operation, deriving from the thermal deformation of the metal (proportional elongation and shortening of the operating temperature are equal to about 0.01 mm per degree centigrade per meter). The intensity of the noise that is more or less strong will depend on many factors, such as the correct calibration of the heating element in proportion to the size of the heater. In addition to the problem of noise tied to the thermal variations of the device, towel warmer and electric radiators on the market today have other problems and other limitations, listed hereinbelow:
they often have a “closed structure” i.e. a structure which, not allowing the exit of internal hot air, generates high and dangerous internal pressures which over time can cause the deterioration of the device components;
having a “closed structure” also leads to a poor efficiency in the heat distribution within an environment, since hot air is not introduced, but rather there is only the propagation of the heat given by the heating of the air outside the device;
the structure type of these devices often constrains them to have an aesthetic appearance that is little “flexible”, i.e. the tubes must be straight (as in the case of the patent application EP3339764A1 by R. SPERANZON and S. VALENTE in which the uprights cannot be curved or undulated since otherwise they would prevent the sliding of the modules, to which the central tunes are connected, into the suitable guides at their interior);

moreover, these devices often show signs of junction between the various elements for structural needs, consequently having limited aesthetic value, as in the case of the patent application GB2451109A by D. LENNON and M. BETZ. It is also underlined that the abovementioned case of the example and all similar cases are characterized by an exchange of heat that occurs mainly by convection within the vertical uprights which, therefore, are heated more slowly than the central tubes. Indeed, hiding the signs of junction with covering elements is an operation that negatively affects the outflow of the air from the junction points of the components, and is also an operation that involves additional times and attainment costs.

The present invention sets the objective of providing an electric heating device with open structure and power regulator that allows overcoming all of the abovementioned problems and involves further advantages that are clear in light of the following descriptions.

Description of the invention According to the present invention, an electric heating device with open structure and power regulator is attained. The electric heating device according to the present invention uses a constant power heating cable (CPC) with power preferably comprised in the range from 10 W/m to 80 W/m, in the absence of heat transfer liquids (as a non-limiting example, water, water mixtures, glycols and/or others). The device is characterized by having a uniform distribution of the heat in all its points and a rapid assembly, since the CPC inserted therein following the shape (i.e. the extension along the direction of greater extension) of one or more core profiles and/or covering elements that compose it, within their entire length and in a continuous manner, avoiding junctions of several parts of cables. The CPC is then inserted within the structure of the device which is defined an open structure, i.e. it allows the passage of hot air from the interior to the outside, and allows the cold air to enter. Being open ensures the structure of the present invention the capacity to accommodate expansions and contractions due to thermal variations. The open structure also allows the use of various different materials with different heat expansion coefficients, always and in any case ensuring a space between the elements such to prevent the obstruction of the slots through which the air passes, and the consequent thrust of the components against each other, which would generate deformations and/or cracks. Among the various materials employed for making the structure, as a preferred but non-limiting or non-binding example, this is made of stainless steel. The tolerances between the various components of the structure and hence the spaces between the same are also evaluated as a function of the final surface finishes, so as to prevent the thicknesses of the finishes themselves (as a non-limiting or non-binding example, paints) from obstructing the slots functional for the passage of air and with the just-described characteristics.

The open structure then comprises one or more core profiles within which one or more CPCs is placed, or several times the same CPC is placed, and one or more covering elements which cover the core profiles and the CPC and attain the open structure. The open structure has, in various embodiments, an aesthetic appearance with flat, round, rectangular shapes and/or other shapes, which is obtained through the application, to the structure of the core profiles, of a set of said covering elements which are shaped “plates” (i.e. elements which as a non-limiting or non-binding example can be metal and press-formed, cold rolled, hot rolled and the like), designed for obtaining an mutual approach with millimetric precision (with size error below 1 mm) and thus to ensure the coplanarity between all the elements. Between the core profiles and the covering elements, direct contact surfaces come to be generated that allow a heat exchange by conduction. Specifically, the heated CPC, in contact with the core profiles, heats them by conduction, then the contact surfaces between core profiles and covering elements ensure that the heat is once again transmitted by conduction to the latter elements. Conduction allows, in a material such as stainless steel, a quicker and more effective propagation (with attainment of higher temperatures) with respect to that obtained by convection (i.e. only heating of the internal air that then, consequently, also heats the covering elements). The presence of contact surfaces that, therefore, is developed over the entire length of the core profiles and covering elements, ensures that the heat distribution is quicker, more uniform and perceived more rapidly outside of the heating device.

The CPC inserted within the device, in compliance with European and American laws, is directly wired with the power grid and/or with a control unit which manages its switching on and off, without the need to use power cables. The wiring operations, which are attained between the CPC and the power grid or between the CPC and the control unit, are carried out by means of seals, anti-tear sealing elements and/or anti-twist sealing elements, crimped sword terminals (i.e. gripped, narrow and deformed so as to remain locked in position) on the conductor wires and connectors and/or electric terminals and these are deemed of obvious and known implementation for a person with ordinary knowledge in the field of application of the invention; therefore, their detailed description will be omitted.

The open structure of the electric heating device has one or more fasteners (fixing to wall and/or to any other support on which the device is mounted) which have both the structural function of bearing the loads of the device, and the function of providing the CPC with a protected and hidden passage for reaching the built-in wall and connected with the power grid or with the control unit. The CPC placed within the core profiles and/or the covering elements thus exits directly (without interruptions and/or intermediate connections) from one or more fasteners of the device allowing the electrical connection in one or more outlet points based on the mounting requirements. In this manner, the electrical connection with power grid or with control unit remains hidden within the built-in wall. The open structure thus comprises suitable empty zones, across from the fasteners, in which it is possible to bend the end of the CPC that was not used for making electrical connections.

The device, in the embodiments in which the open structure is of “ladder” type (i.e. the most classic form in which the towel warmers are attained, which is composed of two perimeter longer elements and various central elements that are coupled to the first two, forming right angles), can have an even number of central elements (whether these are core profiles and/or covering elements), in this manner the CPC, which is inserted therein in a coil arrangement, has start and end (both connectable to the power grid or to the control unit) arranged along the same perimeter element. When there is an odd number of central elements, however, the CPC has start and finish (both connectable to the power grid or to the control unit) on two different perimeter elements. The presence of start and finish of the CPC on the same perimeter element allows having the two possible points of electrical connection of the device along the same vertical such that, by rotating the device by 180° on the plane parallel to the support (e.g. a wall) on which one wishes to install it, it is possible to make a connection at the bottom right and top right, or at the bottom left and top left, maintaining the aesthetic configuration of the device unchanged in all four cases. Since the electrical connections with the control unit and/or with the power grid attained in situ (i.e. at the time of mounting and on the mounting site), the device can also be rotated by 90° or by 270° (having a horizontal arrangement for example) or by any one other angle on the plane parallel to the support based on client preferences. The possibility of connecting the CPC in one of the two points, along a perimeter element and the possibility of in any case maintaining the control unit (coupled in situ) in a straight position, not being connected with rigid, unique pieces (as an example a single press-formed profile) to the device, allows the maximum flexibility thereof (i.e. possibility of personalized positioning) in the mounting.

The device of the present invention, in several embodiments thereof like that described above (“ladder” with two long perimeter elements to which various central elements are coupled) has central elements and perimeter elements with internal dimensions such to allow more than one passage of the CPC and/or the passage of more than one CPC. The passages of the CPC are made, as a non-limiting or non-binding example, in coil form, first starting from one side, and in the second passage or with the second CPC, starting from the other side. Other possible arrangements of a single CPC provide for the entrance of the CPC into a central element, its extension within the entire element, a “U”-shaped curved at the end of the same, and the return into the same element, passing a second time therein, once it has passed twice in a tube; the CPC is arranged in the same manner in all the central elements, taking care—after having performed a single passage in the last central element—in order to then be able to extend the CPC within the entire length of the perimeter element in which it has not yet passed.

All the possible configurations—described and not described—have the purpose of avoiding the presence of cold zones on the central elements and/or on the perimeter elements. The increased internal dimensions of the elements that constitute the open structure are attained such to prevent the onset of problems of electromagnetic interference between two proximal CPCs (or between two proximal branches of the same CPC) in compliance with the inductivity limits of said CPC.

The described characteristics of the invention thus allow making dry electric radiators with structures that can easily be adapted to various supports and geometries of the space, having a variable and personalizable shape without constraints tied to the operating efficiency and allowing the attainment of structures with considerable aesthetic value. The possibility of having the entire surface of the electric device as heat-radiating surface allows having devices of various dimensions (in a range preferably comprised between 25 cm and 210 cm both in height and in width and with tubular elements with minimum internal dimensions preferably comprised between 8 mm and 100mm) and capable of performing towel warmer function by delivering power preferably comprised between 5 and 600 W or heat radiator function delivering power preferably comprised between 600W and 2500W.

High delivery power allow developing high temperatures within the device that is therefore subjected to high internal pressures. These pressures increase at the moment when clothes, towels or other often still-wet elements are placed on the central elements of the device.

In order to overcome this problem, the solution proposed by the present invention is that of making a dry electric device with said open structure which allows dissipating the internal pressures instantaneously and also having a greater passage of hot air towards the outside. The open structure, as already anticipated, is attained with core profiles and covering elements. The core profiles are, as a non-limiting or non-binding example, press-formed plate profiles with open section that is “L” shaped, “C” shaped and/or has another form.

The core profiles and the covering elements are coupled together through coupling systems of various type, for example:
a system by crimping of two press-formed plates;
a “latch” system, in which one uses a latch, i.e. an element (preferably a sheet with open section, e.g. “L” shaped) with geometry and section such to be able to be inserted between covering elements and core profiles by means of manual pressure and/or with the use of mechanical tools (as a non-limiting or non-binding example grippers), and which maintains elements and profiles stopped in the desired position (the position attained by the finished final configuration of the structure) by means of mechanical interference, i.e. via pressure, via traction, by triggering pull-push mechanisms, by triggering lever mechanisms and/or the like;
a joint system with tabs and slots, in which projections (“tabs”) on the core profiles and/or on the covering elements come to be fit within slots (slits with thickness and geometry such to allow the insertion and the joint of the tabs).

According to one embodiment of the present invention, the device, and hence its open structure, have the external appearance of a single profile (with section which as a non-limiting or non-binding example can be rectangular, circular, semicircular and/or other).

According to another embodiment of the present invention, the covering elements are a coupling plate, a front plate and a perimeter covering element. In this embodiment, the coupling plate is a plate with various shape, on which fasteners that anchor it to the support are connected. The front plate is instead an element with minimal aesthetic appearance that can include, as a non-limiting or non-binding example, inserts made of precious material, one or more mirrors and still other items. In the part of the front plate that is situated across from the coupling plate, the core profiles are positioned, within which the CPC is arranged. The perimeter covering element is finally an assembly of one or more elements that allows attaining a frame such to generate a distance cavity designed to generate a chimney effect in which the hot air exits from the upper part and the cold air enters from the lower part. The assembly of the structure of the device in this embodiment provides for mounting the core profiles on the face of the front plate that is directed towards the support, for coupling together the perimeter covering element and the coupling plate, and finally for coupling the front plate to the coupling plate placed on the support.

In several embodiments, the various components of the open structure can be held together through riveting in which each rivet is sized in order to have a tolerance such to support the thermal deformations of the various elements.

As already mentioned, another innovative aspect of the present invention consists of the presence of a power regulator. The power regulator is connected to a suitable probe for measuring the temperature within the device.

In one embodiment of the present invention, the power regulator is also provided with one or more connections with thermostats or any type of environmental temperature sensors.

The power regulator is therefore involved with managing the flow of energy with inverter technology up to the set energy level. The device, in fact, provides for the division of the maximum stated power into various operating power levels (whose number is variable and personalizable) associated with the same number of temperature levels. The power regulator electronically cuts the excess energy quantity, preventing the dissipation thereof into other points with consequent energy waste. The power regulator and thus (as seen) temperature regulator maintains the flow of energy constant, consequently causing the consumption thereof. The electronic management-in order to reach the desired temperature-avoids having to operate the electric heating device in switch on-off intervals at maximum power, allowing the simultaneous use of multiple appliances in compliance with the electrical energy availability. The software of the power regulator therefore manages the electric power by means of wave cut which throttles the absorbed power, so as to considerably limit the electromagnetic disturbances and consequently allowing to have more space in the hardware of the power regulator and of the control unit for the insertion of safety components (as a non-limiting or non-binding example a safety fuse in order to protect the electrical plant from possible short-circuits and overloads) requested for the certification for European and American laws and/or others.

The advantages offered by the present invention are evident in light of the description set forth up to now and will be even clearer due to the enclosed figures and to the relative detailed description.

### DESCRIPTION OF THE FIGURES

The invention will be described hereinbelow in at least a preferred embodiment by way of example and non-limiting with the aid of the enclosed figures, in which:

FIG. 1 shows a perspective view of an electric heating device 100 and several connection operations with a control unit 110;

FIG. 2 shows a sectional perspective view of the control unit 110;

FIG. 3 shows a front and sectional view of an electric heating device 100;

FIG. 4 shows an exploded view (FIG. 4A) of a structure 200 of an electric heating device 100 and four details (FIG. 4B, C, D, E) of the arrangement of the CPC 10, of the assemblies between the core profiles 201 and the covering elements 202 that compose it;

FIG. 5 shows a rendering (FIG. 5A) of an electric heating device 100 with said structure 200 and four details (FIG. 5B, C, D, E) of the assembly of the core profiles 201 and of the covering elements 202 that compose it;

FIG. 6 shows a rendering (FIG. 6A) of an electric heating device 100 with said structure 200 and a detail (FIG. 6B) of the assemblies of the core profiles 201 and of the covering elements 202 that compose it;

FIG. 7 shows a rendering (FIG. 7A) of an electric heating device 100 with said structure 200 and three details (FIG. 7B, C, D) of the assembly of the core profiles 201 and of the covering elements 202 that compose it;

FIG. 8 shows a rendering of an electric heating device 100 with said structure 200 and two details (FIG. 8A, B) of the assembly of the core profiles 201 and covering elements 202 that compose it.

### DETAILED DESCRIPTION OF THE INVENTION

The present invention uses the dry electrification process that consists of the insertion of a single heating element (constant power cable CPC 10) distributed along the entire the structure 200 of an electric heating device 100 which can be a towel warmer and/or a radiator, in the absence of heat transfer liquids at the interior. electrification system and the structure 200 of the electric heating device 100 allow obtaining various advantages and overcoming numerous technical problems:
ensuring speed in reaching the maximum temperature of the heating element of the CPC 10, hence the heat is perceptible in a few minutes;
ensuring the uniform heat distribution along the entire radiating surface and preventing that cold parts remain in products with large size or particular shapes (e.g. undulated shapes, angled shapes and others);
preventing energy waste and allowing a modulation of the input electric power and consequently a thermal regulation through a suitable power regulator 111. Specifically, a software 112 which is installed on the power regulator 111 allows cutting the input electric power and the relative wave forms, also allowing the use of the electric heating device 100 at low temperatures, without varying the aesthetic and size characteristics thereof and in any case with complete compliance with current laws. The software 112 then throttles the absorbed power in order to limit the electromagnetic disturbances;
eliminating annoying noise tied to the thermal expansion and contraction of the material or of the materials constituting the structure 200 itself of the dry electric heating device 100;
preventing the development of high and dangerous pressures within the electric heating device 100 having a structure 200 that is open, i.e. such to allow the outflow of air;
increasing the effectiveness in perceiving the heat in proximity to the electric heating device 100 due to the chimney effect that the open structure 200 is capable of developing, by making hot air exit outward and suctioning in cold air;
having an electric heating device 100 of aesthetic value and on which the signs of junction of the various components are hidden (and hence directed towards the support 1 on which it is installed) or suitably shown as design selection (but not as structural requirements);
having an electric heating device 100 with a structure 200 that can have various forms, not only straight, but also curved and/or undulated in all spatial directions (as a non-limiting or non-binding example, curvature in the plane and outside of the plane parallel to the support 1 on which the electric heating device 100 is coupled)
having an electric heating device 100 assemblable in rapid times, not necessarily requiring the execution of welding but also allowing a simple manual assembly in which the CPC 10 is manually inserted in the various components and elements of the structure 200 which are then fit together with joint systems with slots and tabs or with “latch” systems (i.e. assemblies such to not require the execution of welding operation such to not require the execution of welding or use of tools whose use is slow and/or complex);
having an electric heating device 100 which allows the passage of the heating element CPC 10 within its structure 200 according to various paths and arrangements (as a non-limiting or non-binding example “coil” arrangement), and within a wall coupling 203 that reaches up to a built-in wall 104 in which it is possible to wire the heating element CPC 10. The possibility of passing the heating element CPC 10 within the wall coupling 203 not only allows having an appearance of greater worth, preventing showing cables and/or other elements used for hiding the same cables, but also allows economic savings by using a same element (the wall coupling 203), both for its structural purpose of bearing the loads of the electric heating device 100, and for hiding and protecting the heating element CPC 10.

In several embodiments of the present invention, the CPC constant power heating cable 10 is cable with double wire having the same power per meter. The two wires (one for the positive pole, one for the negative pole) are wound with two insulating sheaths interrupted at regular intervals in order to ensure that a heating spiral wire (as a non-limiting example in nickel-chrome alloy) wound on the sheaths can have contact points with the wires at regular intervals. Wires, sheaths and heating wire spiral are all wound by an insulation, e.g. silicone rubber.

In several embodiments thereof, the CPC cable 10 can be provided with external metallic mesh order to ensure a mechanical protection addition and the grounding of the cable.

In other embodiments of the present invention, the CPC cable 10 is a self-regulating. A self-regulating CPC cable 10 is a cable with two conductors which feed a conductive internal core of graphite. The graphite particles constitute many connections in parallel between the two wires. When the heating cable is cold, the core is microscopically contracted and the graphite constitutes numerous connections between the wires. The passage of current generates heat and in the hottest points it is microscopically expanded, thus breaking several electrical contacts. Increasing the electrical heating element decreases the energy emission, up to reaching a thermal equilibrium between the heat losses and the heat power produced by the cable. A very high temperature ensures that the microscopic expansion of the core interrupts nearly all the contacts. One such self-regulating CPC cable 10 cannot be overheated and burn, being autonomously protected by means of the just-described mechanism. In this embodiment of the present invention, the function of power regulator is, in light of that just described, completely or partly performed by the same self-regulating CPC cable 10.

The structure of the electric heating device 100 and the nature of the connections, of the cables, of the heating elements and of the hardware used are such to be water resistant even at the time when this must enter within said open structure.

The structure 200 is adapted to allow the passage of air, to accommodate expansions and contractions due to thermal variations and comprises:
one or more core profiles 201 within which one or more CPC 10 passes and/or within which said CPC 10 passes one or more times;
one or more covering elements 202 adapted to cover several core profiles 201 and said CPC 10, to attain an open structure which allows hot air to escape and cold air to enter, and to be coplanar when combined together to generate an aesthetic effect of surface continuity; said core profiles 201 and/or said covering elements 202 having a straight, curved and/or wavy shape shape both in the plane and out of the plane parallel to the support 1 on which the electric heating device 100 is installed;
one or more contact surfaces 205 between said core profiles 201 and said covering elements 202 which allow a heat exchange by conduction which speeds up the heat distribution and increases the heat reached on said external covering elements 202;
one or more wall couplings 203 with both a load-bearing structural function, being adapted to couple the structure 200 to a support 1, and protective function and such to hide said CPC 10 that passes at their interior; said CPC 10 passing within said core profiles 201 and said wall coupling 203 in order to reach in a built-in wall 104 in which it is connected to the power grid or to a control unit 110;
one or more folding spaces 210 in front of said wall coupling 203, from the internal side of the structure 200, in which the unused end of said CPC 10 for the electrical connection is folded.

The open structure 200 originates for meeting the above-described needs and is strictly tied to the technical practice of insertion of the CPC cable 10 at its interior. The synergy between an open structure 200, as described, and the practice of inserting the CPC cable 10 at its interior allows attaining the abovementioned advantages, not possible if one of the two elements (structure 200 or heating element CPC 10 inserted therein) is not present.

In several embodiments of the present invention, the covering elements 202 are press-formed profiles with open section (e.g. “C” shape section, “L” shape section, of “IPE” type and/or other form, i.e. with a non-closed section). Said press-formed profiles can be attained with material of various type, as a non-limiting or non-binding example steel, aluminum, aluminum coated with plastic materials and/or others and/or with different finishes.

In several embodiments of the present invention, said covering elements 202 can be assembled by means of crimping together and/or with said core profiles 201 to generate an aesthetic effect of continuity.

In several embodiments of the present invention, said covering elements 202 can be assembled together and/or with said core profiles 201 through a “latch” joint, using an element termed latch 207 consisting of a plate with geometry and section such to allow the locking via mechanical interference (i.e. creating a mechanical constraint via compression, traction, and/or creating a pull-push mechanism) with said covering elements 202 and/or with said core profiles 201. Said latch 207 is positioned by means of pressure exerted manually and/or with mechanical tools.

In several embodiments of the present invention, there are tabs 208 and slots 209 which fit into each other in order to maintain said covering elements 202 and/or said core profiles 201 locked in the desired position (i.e. in the final position configured as a design, a position such to ensure the immobility of the single elements and the solidity of the structure 200).

The coupling of tabs 208 and slots 209 supports possible twists and allows the device 1 flexibility during installation on a support 1, also in the case of very irregular supports and not perfectly planar (as a non-limiting or non-binding example rustic brick walls, out of plumb walls and others).

In various embodiments of the present invention said core profiles 201 and/or said covering elements 202 have straight, curved and/or wavy shape shape both in the plane and out of the plane parallel to the support 1.

The power regulator 111 is a device constituting part of a control unit 110. The control unit 110 has an interface with buttons, screen, lights and in several embodiments also includes microphone and speakers. The control unit 110, in addition to comprising the electronic circuit board with the power regulator 111, also comprises an electronic logic board 113 adapted to receive the inputs acquired by means of the interface, to supply output on screen, lights and speakers, and to communicate with said power regulator 111 so to ensure that the electric heating device 100 consumes the requested power and reaches the temperature indicated on the interface.

In several embodiments of the present invention, the power regulator 111 and the electronic logic board 113 are several meters away or tens of meters away. In these embodiments of the present invention, the power regulator 111 is connected to the electronic logic board 113 by means of electric connection with cables (the electric connection with cables is deemed an obvious and known implementation for a person with ordinary knowledge in the field of application of the invention and therefore is not described in detail herein) and/or by means of connection wireless, when each is provided with wireless communication apparatuses.

Said electronic logic board 113, which is attained as a non-limiting or non-binding example with SMD (Surface Mounting Device) technology, has a limited thickness, preferably smaller than 1 cm, and has electronic components such to not be affected by the temperatures of the electric heating device 100, so to be able to be mounted on the electric heating device 100 itself (as a non-limiting or non-binding example, within recesses and/or holes arranged in the core profiles 201 and/or in the covering elements 202) in several embodiments of the invention.

Both the electronic logic board 113 and the power regulator 111 of the control unit 110 are covered with a protective box and/or with insulation materials such to ensure resistance to fire and to water.

The control unit 110 is housed in a built-in wall 104 and has an inlet through which it can be coupled directly to a wall coupling 203 of the structure 200 electric heating device 100, allowing the electrical connection with the wires of the CPC 10 exiting from said wall coupling 203. Said built-in wall 104 is a recess in the wall which acts as support 1 for the electric heating device 100 in which an electrical box is situated, within which it is possible to carry out a connection with the power grid. The wall coupling 203 comprises a hole made on the core profile 201 and/or on the covering elements 202 of the structure 200 of the electric heating device 100, a thread and a threaded tube which is a preferably cylindrical element with internal thread such to be able to be screwed and hide the CPC 10 that traverses it in order to reach the built-in wall 104 and be directly connected with the control unit 110 or with the power grid. Said wall coupling 203 also having a structural support function, firmly connecting the electric heating device 100 with said built-in wall 104. The power regulator 111 is connected to a probe for measuring the temperature within the electric heating device 100.

In one embodiment of the present invention, the power regulator 111 is provided with one or more connections with thermostats, chronothermostats or any type of environmental temperature sensors.

The power regulator 111 manages the flow of energy with inverter technology up to the set energy level. The control unit 110 in fact allows selecting from between various power levels (and hence temperature levels), whose number is personalizable, for operating the electric heating device 100. The power regulator 111 electronically cuts the quantity of excess energy, preventing the dissipation thereof into other points with consequent energy waste. The electronic management operated by the power regulator 111, in order to reach the desired temperature, prevents the need to operate the electric heating device 100 in switch on-off intervals at maximum power, allowing the simultaneous use of multiple appliances in compliance with the electrical energy availability. The power regulator 111 has a software 112 which manages the electric power by means of wave cut.

In one embodiment of the present invention, the control unit 110 which communicates with wireless protocol is accessible, manageable through a mobile device as a non-limiting or non-binding example such as a smartphone, a tablet, a PC and/or others.

The absence of heat transfer liquids (as a non-limiting or non-binding example, a mixture of water and glycols) within the electric heating device 100 allows the installation thereof in any position and orientation (imagining the rotation of the device on the plane parallel to the support on which one wishes to install it) without performance limits, even in large-size products. The electric heating device 100 according to the present invention is mountable with orientation in any direction (in the plane parallel to a support 1 on which a wall must be mounted, as a non-limiting or non-binding example), said CPC 10 coming out of two wall couplings 203, directly connectable with the power grid and/or with said control unit 110 from the desired side and reinsertable within the structure 200 from the unused side.

Another prerogative of the electric heating device 100 of the present invention and of its electrification system is also the flexibility of the applications possible in non-linear structures, which the conventional methods do not usually allow. The power regulator 111 in radiators, used for heating, achieves the principle of optimization in the use of energy, since it allows effectively managing the power employed with control of the consumptions and greater energy efficiency.

The electric heating device 100, based on the power delivered by the CPC 10 and its dimensions can have a towel warmer function by using a CPC 10 which delivers a power comprised between 5 W and 600 W, and/or it can have the function of space heating by using a CPC 10 which delivers a power greater than 600 W.

In several embodiments of the present invention, the electric heating device 100 has a uniform distribution of the heat in all its points, said core profiles 201 and/or covering elements 202 having internal dimensions such to allow more than one passage of the CPC 10 and/or the passage of more than one CPC 10, preventing the onset of problems of electromagnetic interference in compliance of the inductivity limits of said CPC 10.

The present invention will now be illustrated as a non-limiting or non-binding example, with reference to the figures which illustrate several embodiments relative to the present inventive concept.

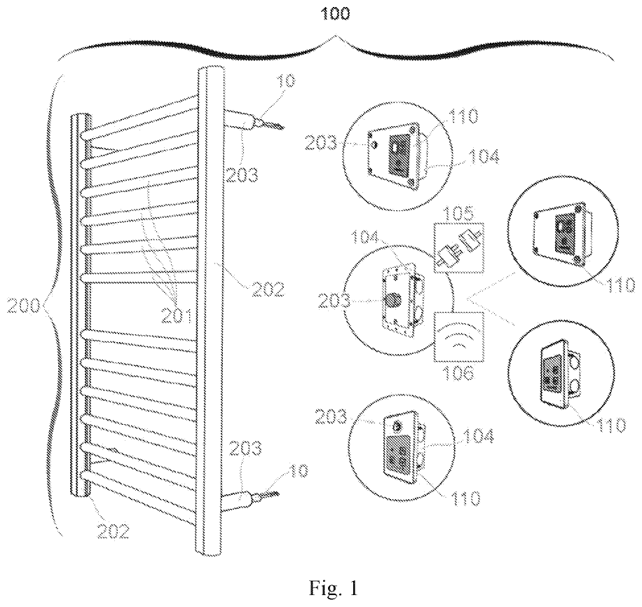

With reference to FIG. 1, a perspective view of an electric heating device 100 is shown together with several connection operations with a control unit 110 according to the present invention. In FIG. 1, as in the following description, the embodiment of the present invention is illustrated which is deemed to be the best up to now.

Said electric heating device 100 comprises said CPC constant power heating cable 10 with power comprised in the range from 10 W/m to 80 W/m, in the absence of heat transfer liquids, inserted within its structure 200 following the shape (i.e. the extension in the direction of greater extension) of one or more core profiles 201 and/or covering elements 202 that constitute it, within their entire length and in a continuous manner, preventing junctions of several parts of cables. The electric heating device 100 has a rapid assembly, said CPC 10 being directly wired (i.e. electrically connected) with the power grid and/or with a control unit 110 which manages its switching on and off, without the need to use power cables. Said core profiles 201 and/or covering elements 202 can have straight (as shown in FIG. 1), curved and/or undulated (as shown in the following figures) shape both in the plane and out of the plane parallel to the support 1 on which the electric heating device 100 is installed. Said electric heating device 100 is mountable with orientation in any direction, said CPC 10 coming out of two wall couplings 203 (as shown in FIG. 1 in which the number of central core profiles 201 is even, the CPC 10 exits from two wall couplings 203 on the same perimeter element composed of multiple covering elements 202), directly connectable with the power grid and/or with said control unit 110 from the desired side (according to the space and power grid requirements of a user who is installing the device) and reinsertable within the structure 200 from the unused side.

Said control unit 110 has an electronic logic board 113 which manages inputs and outputs on a user interface, and has a power regulator 111 with a software 112 suitable for controlling the electric power by means of wave cut which throttles the absorbed electric power so as to keep constant the flow of energy towards the CPC 10 as a function of the desired temperature, preventing switch-off and switch-on cycles at maximum power and allowing the simultaneous use of multiple appliances in compliance with the availability of electricity.

In the perspective shown in FIG. 1, imagining the desire to connect the electric heating device 100 with the control unit 110 positioned on the left, it will suffice to rotate the electric heating device 100 by 180° on the plane parallel to the wall on which one wishes to mount the device and the two wall couplings 203 will be found available on the left. The same reasoning can be made if one wishes to arrange the electric heating device 100 according to a particular direction different from the vertical (vertical direction shown in FIG. 1), in which it will suffice to rotate the electric heating device 100 by the desired angle. In each of the above-described cases, the operation of the device is not at all negatively affected.

FIG. 1 also shows various possibilities of connection through said wall coupling 203. The following are shown in the circled details: a horizontal control unit 110 with display, an electrical box which can contain a connector 105 or a wireless acquisition and transmission unit 106, and a vertical control unit 110, all inserted in a built-in wall 104.

The central circled detail shows that, when said control unit 110 is remote and hence distant from the electric heating device 100, said CPC 10 is directly connected to a connector 105, in the electrical box in said built-in wall 104, through which a wiring is then carried out, by using electric cables, with the control unit 110 (which can be horizontal or vertical, with display or no display and with another technology, as already discussed). The case shown in the central circled detail provides that, after any electrical connection, the built-in wall 104 with the relative electrical box is covered with a layer of paint, concrete and/or another material/element, allowing the threaded pin to project outward, on which the wall coupling 203 is inserted. In this manner, the connection wall coupling 203—built-in wall 104 has a load-bearing function for the electric heating device 100.

In addition, when said control unit 110 is remote and uses a wireless communication protocol, said CPC 10 is directly wired to a wireless signal acquisition and transmission unit 106 comprised within the built-in wall 104.

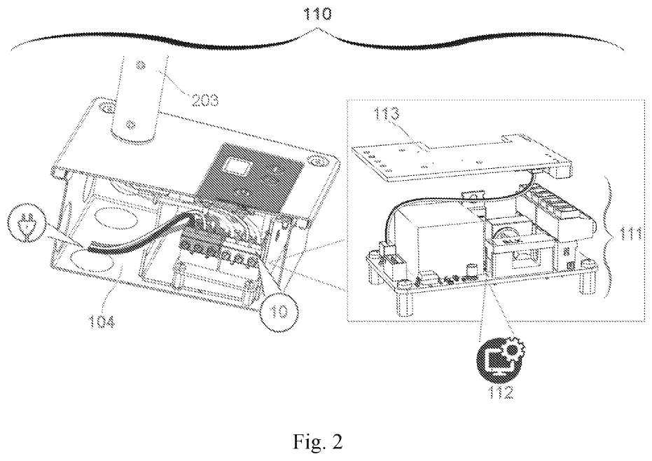

With reference to FIG. 2, a sectional perspective view of the control unit 110 is shown.

Said control unit 110 arranges a series of connectors for electric cables in order to allow the connection to the power grid and to the CPC 10. In the detail shown in FIG. 2, the power regulator 111 is observed with its software 112 together with the electronic logic board 113. Said electric heating device 100 has a power regulator 111 shown in the detail in FIG. 2 which is installed within the built-in wall 104. Behind the interface with display and buttons of the control unit 110, said electronic logic board 113 is positioned and connected by means of cables with said power regulator 111. The power regulator 111 has a software 112 suitable for controlling the electric power by means of wave cut which throttles the absorbed electric power so as to keep constant the flow of energy towards the CPC 10 as a function of the desired temperature, preventing switch-off and switch-on cycles at maximum power and allowing the simultaneous use of multiple appliances in compliance with the availability of electricity.

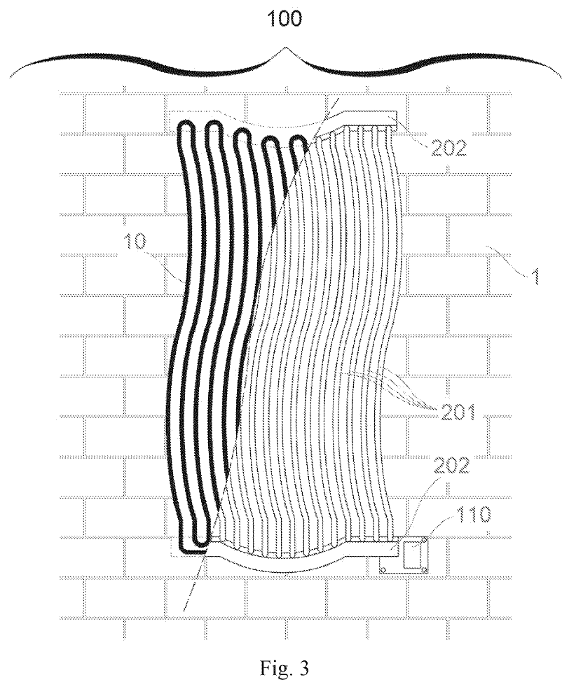

With reference to FIG. 3, a front view and sectional view is shown of an electric heating device 100. The electric heating device 100 shown in FIG. 3 has both core profiles 201 and covering elements 202 with shapes that take on various curvatures on the plane parallel to the support 1 which is a brick wall. FIG. 3 also shows, through a section, the “coil” arrangement of the CPC 10 within the electric heating device 100.

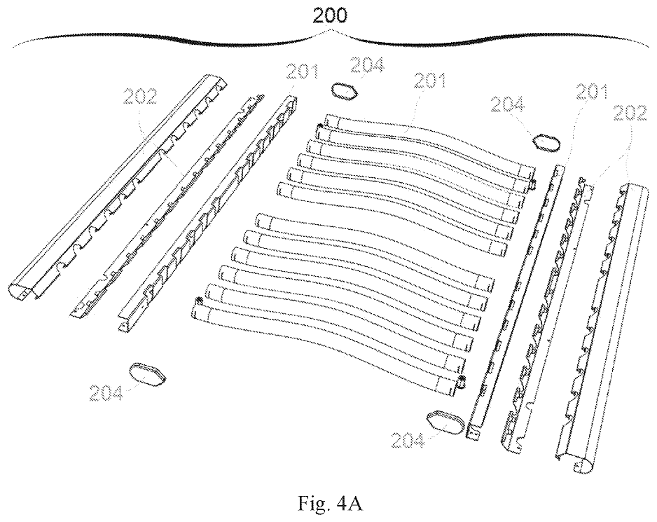

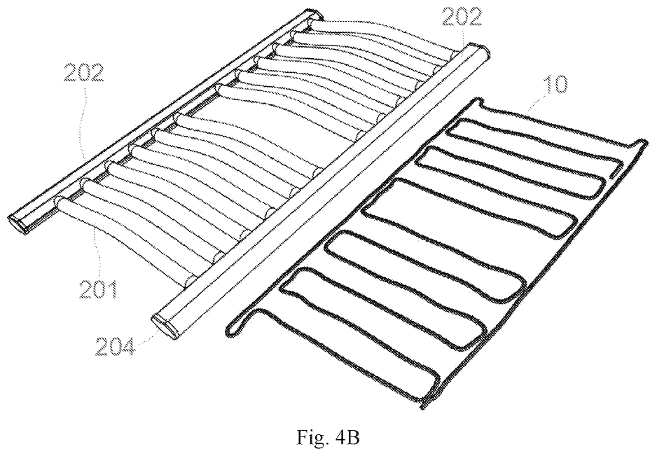

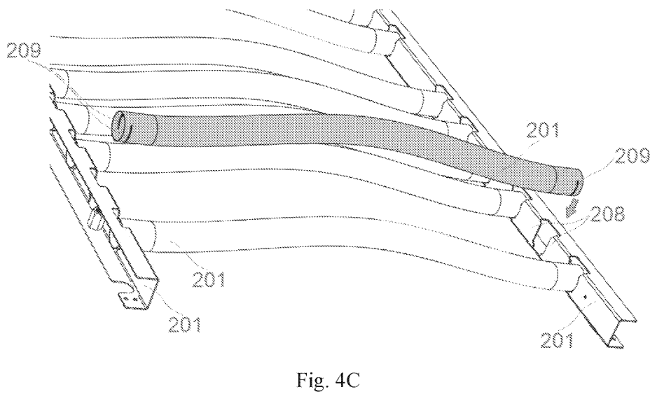

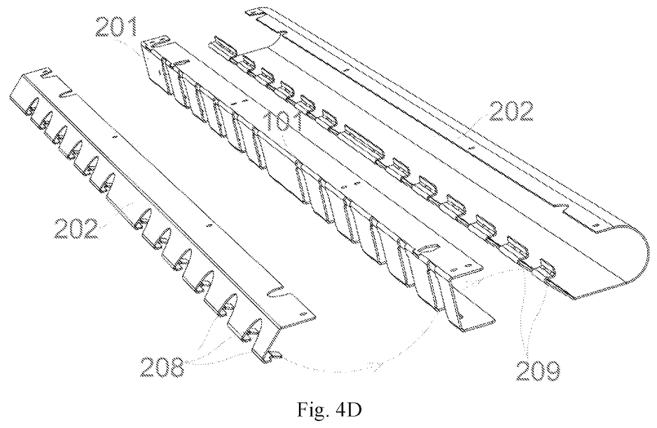

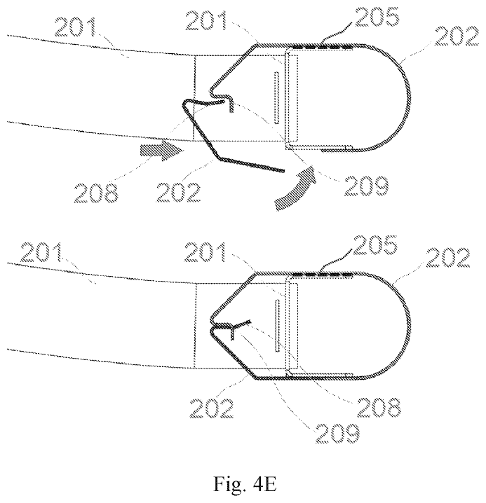

With reference to FIG. 4, an exploded view (FIG. 4A) is shown of a structure 200 of an electric heating device 100 together with various details (FIG. 4B, C, D, E) according to the present invention.

It is observed in FIG. 4 that the structure 200 attains an electric heating device 100 of towel warmer type in which the core profiles 201 are twelve curved tubes arranged parallel to each other, within the CPC 10 is “coil” positioned as shown in FIG. 4B, and two core profiles 201 press-formed, “C” shaped and perforated in order to allow the insertion of the twelve curved tubes. On each of the two press-formed, “C” shaped core profiles 201, two covering elements 202 are mounted. Said covering elements 202 have tabs 208 and slots 209 which fit into each other in order to maintain said covering elements 202 locked in the desired position, i.e. to cover core profiles 201 and in position such to have the junction lines between one covering element 202 and the other towards the support 1 and hence hidden.

FIG. 4A also shows the presence of closure caps 204 which are welded to the ends of covering elements 202. The welding of the closure caps allows carrying out finishing treatments, as a non-limiting or non-binding example that of galvanizing.

The detail shown in FIG. 4B shows the structure 200 mounted and next to the arrangement of the CPC 10 as a coil that is situated therein.

The detail shown in FIG. 4C shows that the curved tubular core profiles 201 are locked, by means of said slots 209 on the tabs 208 of a press-formed, “C” shaped core profile 201.

The detail shown in FIG. 4D shows instead that the two covering elements 202 are together closed around said press-formed “C” shaped core profile 201 through said tabs 208 and said slots 209.

In conclusion, the details shown in FIG. 4E show a section of the covering elements 202 and of said press-formed “C” shaped core profile 201 during and at the end of the mounting step. FIG. 4E also shows a contact surface 205 (dashed black line) that allows a heat exchange by conduction between said press-formed “C” shaped core profile 201 and said covering elements 202.

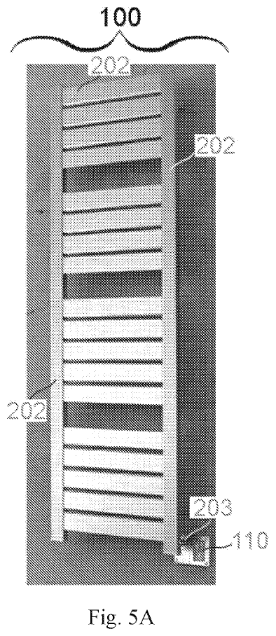

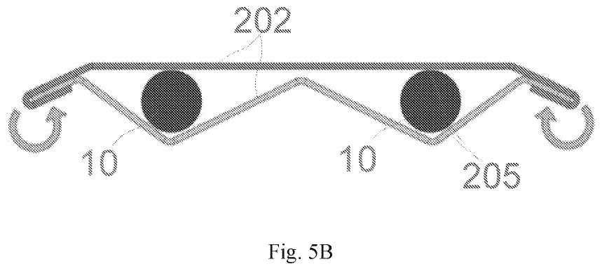

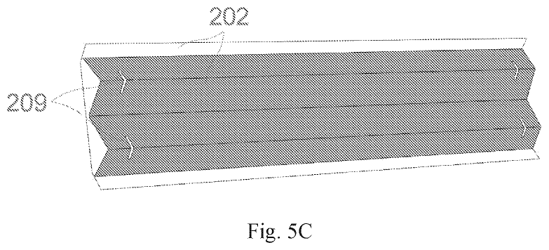

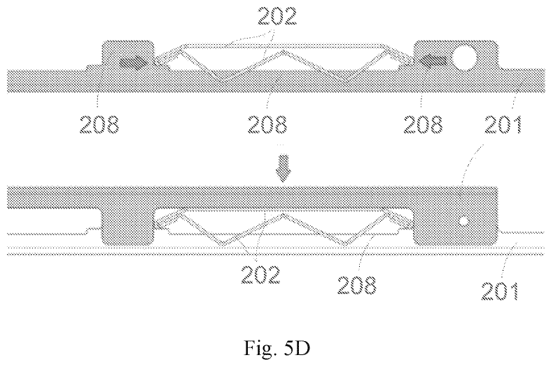

With reference to FIG. 5, a rendering (FIG. 5A) is shown of an electric heating device 100 with said structure 200.

In FIG. 5A, one can observe that the structure 200 of the electric heating device 100 comprises rectangular covering elements 202 and a control unit 110 directly connected to the structure 200 with said wall coupling 203.

The detail in FIG. 5B shows the section of the central covering elements 202 of the structure 200, in which it is noted that the section is attained by means of crimping (executed in the points with the circular arrows) of two covering elements 202, and that the section allows two internal spaces for the passage of two CPCs 10 or for two passages of the same CPC 10. FIG. 5B also shows the contact surfaces 205 between said CPC 10 and said covering elements 202. The detail in FIG. 5C shows the underlying part of the central covering elements 202 of the structure 200 on which it is possible to see four slots 209.

The details in FIG. 5D show that a central tab 208 of a first core profile 201 is inserted in said slots 209 (shown in FIG. 5C) of the central covering elements 202 of the structure 200, while two other more projecting tabs 208 lock its central covering elements 202 in position, preventing the sliding thereof along said low tab 208.

Additionally, the lower FIG. 5D shows a second core profile 201 arranged above the first core profile 201 and the central covering elements 202 whose slots 209 (shown in FIG. 5C) house said central tab 208. The lower detail in FIG. 5D shows that said second core profile 201 prevents said central covering elements 202 from being moved in a direction such to cause the exit of said central tab 208 from said slots 209 (shown in FIG. 5C). The points of contact between said central tab 208 and said slots 209 generate contact surfaces 205 (not indicated in the figure).

The detail in FIG. 5E shows an exploded view of said structure 200 of said electric heating device 100 in which it is possible to observe said first and second core profiles 201, said central covering elements 202, and two lateral covering elements 202 which are closed around said first and second core profiles 201. It is observed that in the case shown in FIG. 5E, said lateral covering elements 202 are closeable with respect to each other by means of tabs 208 which are inserted in the slots 209 (not shown in the figure).

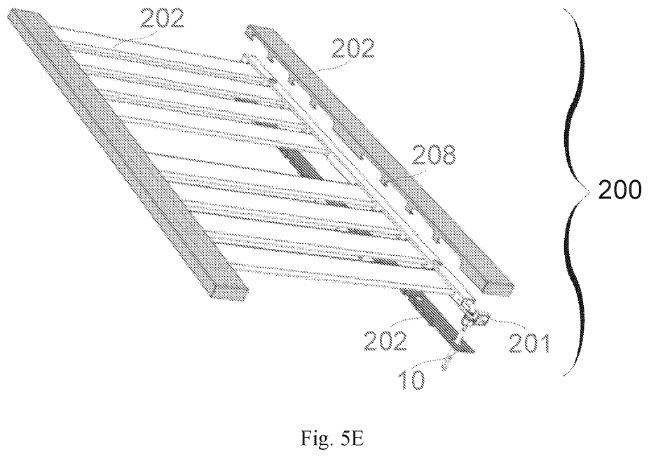

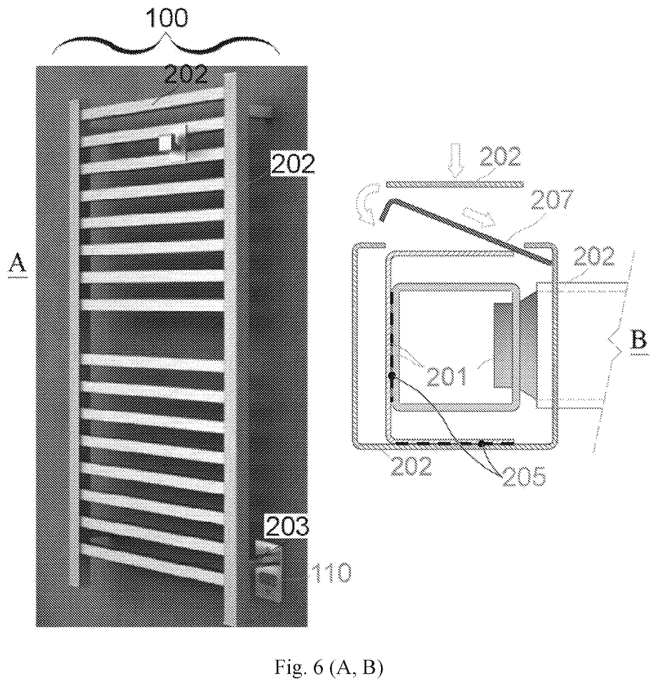

With reference to FIG. 6, a rendering (FIG. 6A) is shown of an electric heating device 100 with said structure 200. The structure 200 of said electric heating device 100 comprises covering elements 202 with square section. In the detail shown in FIG. 6B, one observes a section of a lateral covering element 202 in which the following are present (starting from the interior towards the exterior): a square first core profile 201, a “C” shaped second core profile 201. FIG. 6B shows a covering element 202, “U” shaped, sectioned and constrained with said second core profile 201 by means of a latch 207 (shown in FIG. 6B with a darker fill). In FIG. 6B it is also observed that the latch 207 is inserted diagonally within the “U shaped” covering element 202 and then bent (curved arrow) in order to enter completely therein. To cover the latch 207, a further flat covering element 202 is inserted (covering element 202 that is higher in FIG. 6B). FIG. 6B also shows a third tubular core profile 201 which is connected within the first square core profile 201, and its relative covering element 202. FIG. 6B finally shows two contact surfaces 205 (with two dashed black lines) which come to be generated between the core profiles 201 and between the covering elements 202, facilitating an exchange of the heat by conduction.

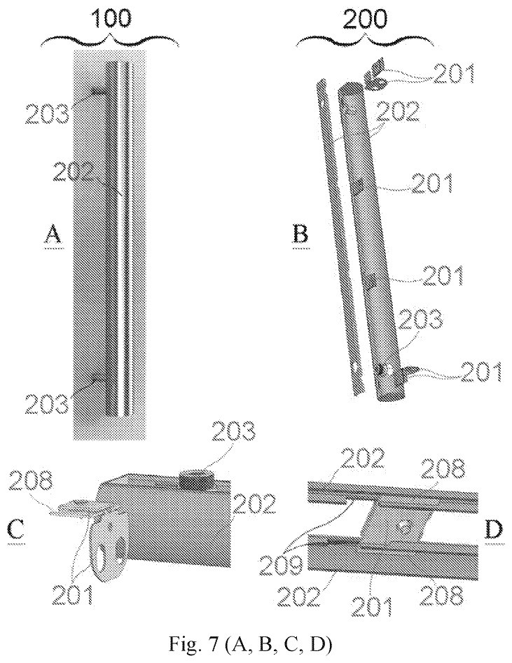

With reference to FIG. 7, a rendering (FIG. 7A) is shown of an electric heating device 100 with said structure 200. The electric heating device 100 shown is aesthetically configured as a single tube with semicircular section with two wall couplings 203.

The detail in FIG. 7B shows an exploded view of the structure 200 of said electric heating device 100, in which it is possible to observe core profiles 201, each having two housings for the passage of two CPC 10 (not shown in the figure) or for two passages of the same CPC 10, and two covering elements 202.

FIG. 7C shows, with an enlarged detail, two core profiles 201 joined together by means of the use of a bolt.

The detail of FIG. 7D shows the fitting of the tabs 208 of said core profile 201 in the slots 209 of said covering element 202.

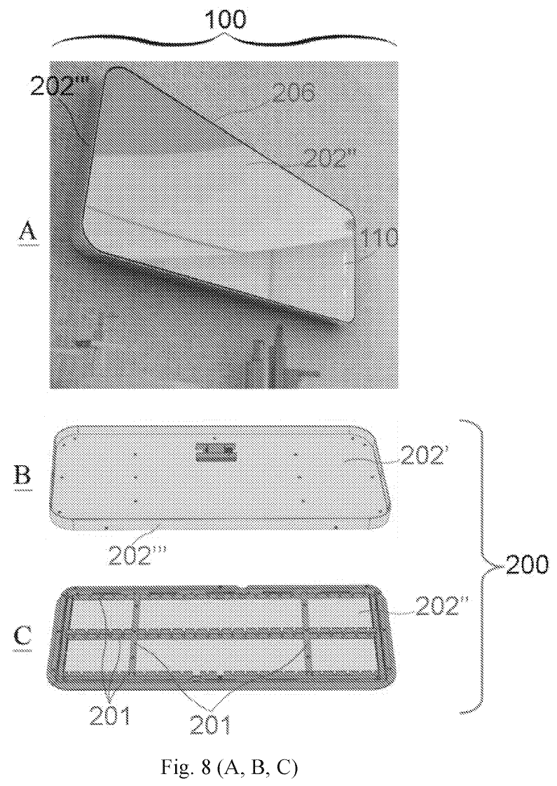

With reference to FIG. 8, a rendering (FIG. 8A) of an electric heating device 100 is shown with said structure 200 according to the present invention. The electric heating device 100 shown is configured as a parallelepiped with rounded angles and with a mirror-like front surface. FIG. 8 shows, in detail, a structure 200 in which the covering elements 202 comprise a coupling plate 202′ (shown in the detail of FIG. 8B), a front plate 202″ and a perimeter covering element 202′″. FIG. 8A shows that said structure 4 is open, there being a cavity 206 between said front plate 202″ and said perimeter covering element 202′″.

Shown in the detail of FIG. 8B is said coupling plate 202′ with said perimeter covering element 202′″.

Shown in the detail of FIG. 8C is the rear part of said front plate 202″, i.e. the part directed towards said coupling plate 202′. On said front plate 202″, core profiles 201 with section “C” shaped, “L” shaped and square are positioned, fixed to the front plate 202″ by means of screws and/or bolts. FIG. 8C shows that said core profiles 201 have grooves in order to allow the housing of said CPC 10 (not shown in the figure).

Finally, it is clear that modifications, additions or variations can be made to the invention described up to now which are obvious for a man skilled in the art, without departing from the protective scope that is provided with the enclosed claims.

1. Electric heating device (100) with CPC constant power heating cable (10) with power included in the range from 10 W/m to 80 W/m, in the absence of heat transfer liquids, inserted inside its structure (200) following the shape of one or more core profiles (201) and/or covering elements (202) that compose it, within their entire length and in a continuous way avoiding junctions of several parts of cables characterized in that it has a rapid assembly, said CPC (10) being connected directly in a built-in wall (104) with the power grid and/or with a control unit (110) which manages its switching on and off, without the need to use power cables; said electric heating device (100) able to be mounted with an orientation in any direction (in the plane parallel to a support (1) on which it is to be mounted), said CPC (10) coming out of two wall couplings (203) which can be connected directly with the electrical mains and/or with said control unit (110) from the desired side and re-insertable inside the structure (200) from the unused side; said electric heating device (100) in which said control unit (110) has an electronic logic board (113) which manages inputs and outputs on an interface for a user, and has a power regulator (111) with a software (112) suitable for controlling the electric power by means of a wave cut which throttles the absorbed electric power so as to keep the flow of energy towards the CPC (10) constant according to the desired temperature, avoiding switch-off and switch-on cycles at maximum power and allowing the simultaneous use of multiple appliances in compliance with the availability of electricity; said structure (200) designed to allow the passage of air, to accommodate expansions and contractions due to thermal variations and to include:
one or more core profiles (201) within which one or more CPCs (10) passes and/or said CPC (10) passes one or more times;
one or more covering elements (202) able to cover some core profiles (201) and said CPC (10), to create an open structure which allows hot air to escape and cold air to enter, and to be coplanar when combined together to generate an aesthetic effect of surface continuity; said core profiles (201) and/or said covering elements (202) having a straight, curved and/or wavy shape both in the plane and out of the plane parallel to the support (1) on which the electric heating device (100) is installed;
one or more contact surfaces (205) between said core profiles (201) and said covering elements (202) which allow a heat exchange by conduction which speeds up the heat distribution and increases the heat reached on said external covering elements (202);
one or more wall couplings (203) with both a load-bearing structural function, being capable of coupling the structure (200) to a support (1), and a protective one, such as to hide said CPC (10) which passes inside them; said CPC (10) passing inside said core profiles (201) and said wall coupling (203) in order to reach a built-in wall (104) in which it is connected to the electrical network or to a control unit (110);
one or more folding spaces (210) in front of said wall coupling (203), on the internal side of the structure (200), in which the end of said CPC (10) not used for the electrical connection is folded.

2. Electric heating device (100), according to claim 1, wherein it has a uniform distribution of heat in all its points, said core profiles (201) and/or covering elements (202) having internal dimensions such as to allow more than one passage of the CPC (10) and/or the passage of more than one CPC (10), avoiding the onset of electromagnetic interference in compliance with the inductivity limits of said CPC (10).

3. Electric heating device (100), according to claim 1, wherein when said control unit (110) is remote and therefore distant from the electric heating device (100), said CPC (10) is directly connected, inside the built-in wall (104), to a connector (105) through which then carrying out a wiring, using electric cables, with the control unit (110).

4. Electric heating device (100), according to claim 1, wherein when said control unit (110) is remote and uses a wireless communication protocol, said CPC (10) is directly wired, inside said built-in wall (104), to a wireless signal acquisition and transmission unit (106).

5. Electric heating device (100), according to claim 1, wherein said covering elements (202) of said structure (200) are press-formed profiles with an open section.

6. Electric heating device (100), according to claim 1, wherein said covering elements (202) of said structure (200) are assembled together and/or with said core profiles (201) by crimping, to generate an aesthetic effect of continuity.

7. Electric heating device (100), according to claim 1, wherein said covering elements (202) of said structure (200) are locked together and/or with said core profiles (201) using a latch (207) which is a shaped element in order to allow elements and profiles to be locked in the desired position by means of pressure exerted manually and/or with mechanical tools.

8. Electric heating device (100), according to claim 1, wherein said covering elements (202) and/or said core profiles (201) of said structure (200) have tabs (208) and slots (209) which fit into each other in order to maintain said covering elements (202) and/or said core profiles (201) locked in the desired position; the joint made with said tabs (208) and said slots (209) supports twists and relative movements, allowing flexibility during assembly on irregular supports (1).

9. Electric heating device (100), according to claim 1, wherein said structure (200) further comprises one or more caps (204) which are welded to the ends of said covering elements (202) allowing the attainment of finishing processes such as galvanizing.

10. Electric heating device (100), according to claim 1, wherein said covering elements (202) comprise a coupling plate (202′), a front plate (202″) and one or more perimeter covering elements (202″); said front plate (202″) and said perimeter covering elements (202′″) being spaced by a cavity (206), through which the passing air generates a chimney effect.

11. Electric heating device (100), according to claim 1, wherein it has a towel warmer function using a CPC (10) which delivers a power of comprised between 5 W and 600 W.

12. Electric heating device (100), according to claim 1, wherein it has the function of space heating using a CPC (10) which delivers a power higher than 600 W.

13. Electric heating device (100), according to claim 1, wherein said control unit (110) is accessible and manageable through a mobile device such as a smartphone, a tablet and/or others.

14. Electric heating device (100), according to claim 1, wherein said CPC cable (10) is a self-regulating constant power cable capable of autonomously performing the function of said power regulator (111).
